(19) United States
(12) Patent Application Publication
(10) Pub. No.: US 2013/0347119 A1
(43) Pub. Date: Dec. 26, 2013

(54) DATA PROCESSOR, COMMUNICATION DEVICE, DATA TRANSMISSION METHOD

(71) Applicant: Kabushiki Kaisha Toshiba, Tokyo (JP)

(72) Inventors: Yasuhiro Morioka, Kanagawa (JP); Yoshinobu Fujiwara, Tokyo (JP); Atsushi Nakajima, Tokyo (JP)

(73) Assignee: KABUSHIKI KAISHA TOSHIBA, Tokyo (JP)

(21) Appl. No.: 13/963,168

(22) Filed: Aug. 9, 2013

Related U.S. Application Data
(63) Continuation of application No. PCT/JP2013/058183, filed on Mar. 14, 2013.

(30) Foreign Application Priority Data
Jun. 21, 2012 (JP) 2012-140142

(51) Int. Cl. G06F 21/10

(52) U.S. Cl. CPC G06F 21/10
USPC 726/26

(57) ABSTRACT

According to one embodiment, a data processor includes: an accepting module configured to accept selection of a transmission destination device to which data is transmitted through a public network line in accordance with a technical standard for transmitting data protected by copyright protection technology, the transmission destination device currently existing in a given environment around the data processor not through the public network line; a first transmission processor configured to transmit a request for transmission of a device registration request including identification information for identifying the transmission destination device based on the technical standard, to the transmission destination device; a receiving module configured to receive the device registration request including the identification information from the transmission destination device; and a second transmission processor configured to transmit the data protected by the copyright protection technology to the transmission destination device identified by the identification information, through the public network line.

### CROSS-REFERENCE TO RELATED APPLICATIONS

This application is a continuation of PCT international application Ser. No. PCT/JP2013/058183, filed Mar. 14, 2013, which designates the United States, incorporated herein by reference, and which is based upon and claims the benefit of priority from Japanese Patent Application No. 2012-140142, filed Jun. 21, 2012, the entire contents of which are incorporated herein by reference.

### FIELD

Embodiments described herein relate generally to a data processor, a communication device, and a data transmission method.

### BACKGROUND

Conventionally, when contents are viewed, or moved and copied (hereinafter also referred to as dubbing) through a network, it is necessary to respect and protect the copyright of contents.

As a technical standard for providing data protected by digital rights management (DRM), copyright protection technology, in an Internet protocol (IP) network arranged in one's home, the digital transmission content protection over Internet protocol (DTCP-IP) is proposed.

Then, when copyright protected data is reproduced or dubbed in a domestic network, the use of DTCP-IP standard is proposed for copyright protection, and the use of digital living network alliance (DLNA) standard is proposed for control of reproduction or dubbing, and transmission.

As a technical standard for realizing the remote use of copyright protected contents, a DTCP-IP remote access standard (hereinafter referred to as DTCP-IP RA) is proposed. The DTCP-IP RA requires that the DTCP device IDs of DTCP sink devices arranged in a same domestic network as of a DTCP source device are preliminarily registered in the DTCP source device in order to restrict the use of copyright protected contents to personal use.

In authentication and key exchange (AKE) processing in remote access, the DTCP source device provides copyright protected contents to only the preliminarily registered DTCP sink devices.

However, in the conventional techniques, there is a case in which the procedure of preliminary registration cannot be started from the side of a DTCP sink device. This is because the DTCP sink device is a portable hard disk drive (HDD) and does not have a user interface for starting preliminary registration, for example.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary conceptual diagram of a network environment according to an embodiment;

FIG. 2 is an exemplary block diagram of a main signal processing system of a television broadcast receiver in the embodiment;

FIG. 3 is an exemplary diagram of a configuration realized by a content processing application of the television broadcast receiver, and a configuration realized in a portable HDD in the embodiment;

FIG. 4 is an exemplary conceptual diagram of processing performed between a digital television broadcast receiver in the embodiment and a portable HDD;

FIG. 5 is an exemplary diagram of a sequence of device registration between a plurality of devices in the embodiment;

FIG. 6 is an exemplary diagram of an example of a selection screen for selecting a device to be registered in the embodiment;

FIG. 7 is an exemplary diagram of a first example of information included in a CDS:X_xxx_StartRemoteRegistration action in the embodiment;

FIG. 8 is an exemplary diagram of a second example of information included in the CDS:X_xxx_StartRemoteRegistration action in the embodiment;

FIG. 9 is an exemplary diagram of a sequence of transmission and reception of copyright protected contents between the devices in the embodiment;

FIG. 10 is an exemplary diagram of an example of a content selection screen in the embodiment;

FIG. 11 is an exemplary diagram of an example of a dubbing destination selection screen in the embodiment;

FIG. 12 is an exemplary diagram of an example of information included in a CDS:CreateObject action of ContentDirectoryService in the embodiment; and

FIG. 13 is an exemplary diagram of an example of information included in header data in the embodiment.

### DETAILED DESCRIPTION

In general, according to one embodiment, a data processor comprises: an accepting module configured to accept selection of a transmission destination device to which data is transmitted through a public network line in accordance with a technical standard for transmitting data protected by copyright protection technology, the transmission destination device currently existing in a given environment around the data processor not through the public network line; a first transmission processor configured to transmit a request for transmission of a device registration request including identification information for identifying the transmission destination device based on the technical standard, to the transmission destination device; a receiving module configured to receive the device registration request including the identification information from the transmission destination device; and a second transmission processor configured to transmit the data protected by the copyright protection technology to the transmission destination device identified by the identification information, through the public network line.

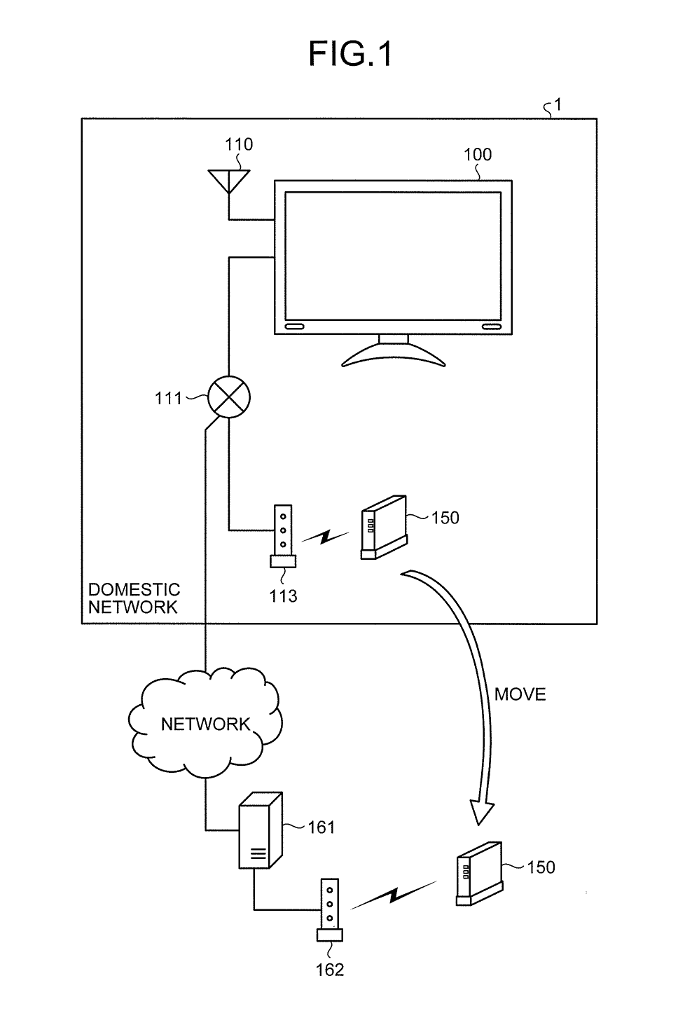

FIG. 1 is a conceptual diagram of a network environment according to an embodiment. As illustrated in FIG. 1, in a domestic network 1, a digital television broadcast receiver (hereinafter also referred to as a television broadcast receiver) 100, a hub 111, a portable HDD 150 that is a portable storage, and a wireless router 113 are provided. In the domestic network 1, the devices are linked to one another by wired or wireless connection.

The portable HDD 150 is connected to a network using a mobile communication technique such as third generation (3G) communication, or a wireless router (wireless router 113, for example), and has a function of obtaining various information from external devices connected through the network and storing it therein. Note that a communication interface of the portable HDD 150 is not limited to a wireless communication interface, and may be a wired communication interface. The portable HDD 150 may perform communication through a personal computer (PC), etc. that is connected via a universal serial bus (USB), etc. In this manner, the communication between the television broadcast receiver 100 and the portable HDD 150 is possible.

The portable HDD 150 can be carried by a user. When the user brings (moves) the portable HDD 150 to the outside of his/her home, the portable HDD 150 can be connected to various devices in the domestic network 1 through an external router 162, a server 161, and an external network.

The television broadcast receiver 100 is connected to an antenna 110, and reproduces or stores contents received through the antenna 110, for example. In the embodiment, a case in which the contents are image data will be described. However, the contents may not be image data, and may be sound data, for example.

In the embodiment, the television broadcast receiver 100 serves as a DTCP source device providing contents, while the portable HDD 150 serves as a DTCP sink device receiving the contents. Thus, in the embodiment, a case in which the DTCP source device is the television broadcast receiver 100, while the DTCP sink device is the portable HDD 150, will be described. However, the DTCP source device and the DTCP sink device are not limited to the television broadcast receiver 100 and the portable HDD 150, respectively, as long as they are devices with which contents are available.

When the portable HDD 150 is connected to a PC, etc. the contents stored in the portable HDD 150 become available in the PC, etc. The portable HDD 150 stores therein contents provided from the television broadcast receiver 100.

Recently, there is a higher tendency to desire to use contents also in the outside of one's home. Therefore, the embodiment is aimed at achieving both the convenience in receiving contents provided and the protection of the contents by copyright protection technology, even when the portable HDD 150 is in the outside of the home.

In the embodiment, when contents stored in the television broadcast receiver 100 is used remotely, DTCP-IP RA is used as a technique for protecting the copyright. Note that the television broadcast receiver 100 may use a subsequent standard using DTCP-IP, instead of DTCP-IP R/.

In DTCP-IP RA, DTCP sink devices need to be preliminarily registered in a DTCP source device in a same home in order to restrict the use of copyright protected contents to personal use. Conventionally, the preliminary registration is started with a registration request transmitted by a DTCP sink device to a DTCP source device as a trigger on the basis of a DTCP-IP remote sink registration (RSR) procedure.

In the case of DLNA, for example, dubbing (copy and move, content moving) is generally performed in a push form using HTTP-POST.

In the push (dubbing) form, a DTCP source device is a client, and transmits contents to a DTCP sink device as a server. This case requires the RSR procedure from the side of the DTCP sink device as a server for the DTCP source device as a client.

However, there is a case in which a sink device is not provided with a user interface for user operation, like the case of the portable HDD 150 in the embodiment. Considering such an aspect also, there is a demand for starting the RSR procedure with operation not on the server (DTCP sink device) side but on the client (DTCP source device) side. Therefore, the embodiment realizes the RSR procedure started with operation of the television broadcast receiver 100 that is the client (DTCP source device) side.

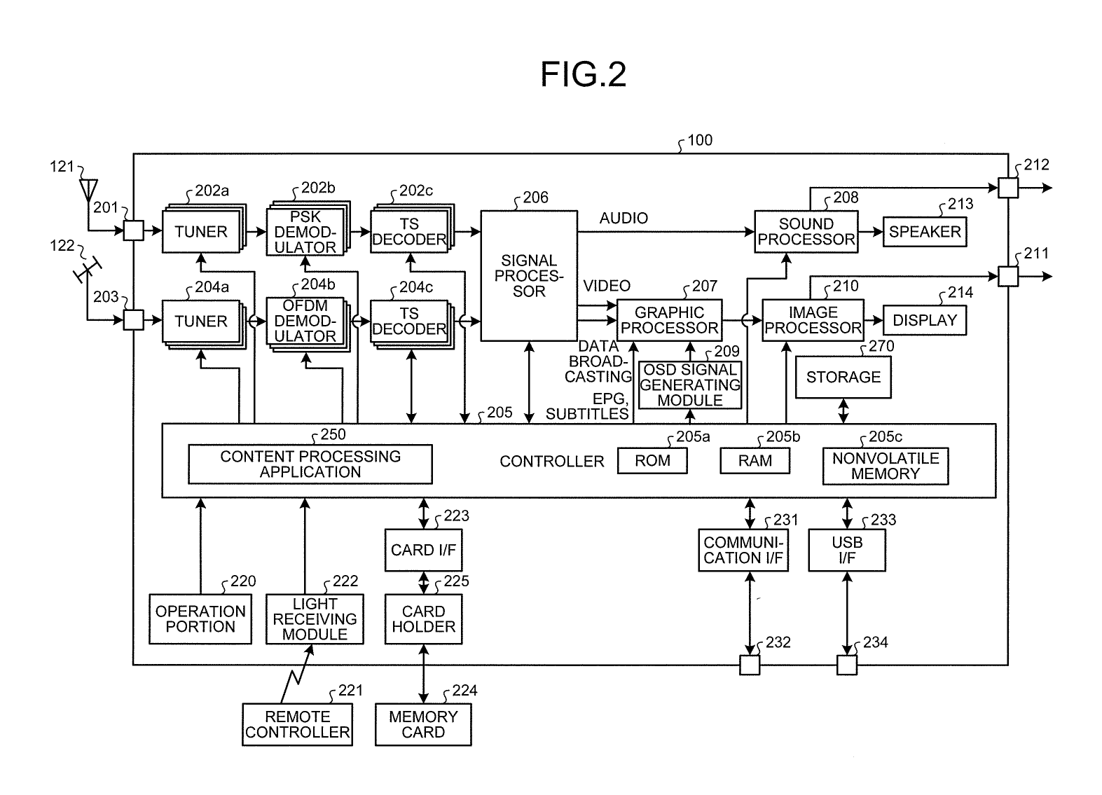

Subsequently, a hardware configuration of the television broadcast receiver 100 will be described. FIG. 2 is a block diagram of a main signal processing system of the television broadcast receiver 100 described above.

Digital satellite television broadcast signals received by an antenna 121 for BS/CS digital broadcast reception are provided to a tuner 202a for digital satellite broadcasting through an input terminal 201.

The tuner 202a selects broadcast signals of a desired channel on the basis of control signals from a controller 205, and outputs the selected broadcast signals to a phase shift keying (PSK) demodulator 202b.

On the basis of control signals from the controller 205, the PSK demodulator 202b demodulates the broadcast signals selected by the tuner 202a, obtains a transport stream (TS) containing the desired program, and outputs them to a TS decoder 202c.

The TS decoder 202c performs TS decoding processing on the TS multiplexed signals on the basis of control signals from the controller 205, and outputs a packetized elementary stream (PES) obtained by de-packetizing digital image signals and sound signals of the desired program to an STD buffer (not shown) in a signal processor 206. The TS decoder 202c outputs section information transmitted through digital broadcasting to a section processor (not shown) in the signal processor 206.

Terrestrial digital television broadcast signals received by an antenna 122 for ground-based broadcast reception are provided to a tuner 204a for terrestrial digital broadcasting through an input terminal 203.

The tuner 204a can select broadcast signals of a desired channel on the basis of control signals from the controller 205. The tuner 204a outputs the broadcast signals to an orthogonal frequency division multiplexing (OFDM) demodulator 204b.

The tuner 202a and the tuner 204a of the embodiment receive, through the antenna 121 and the antenna 122, respectively, broadcast signals of multi-view distribution that provides a plurality kind of image information, as broadcast signals of channels. The broadcast signals of multi-view distribution do not necessarily include all image information. For example, only main image information is included as image information and, with respect to auxiliary image information, only address information of image resources may be embedded therein.

On the basis of control signals from the controller 205, the OFDM demodulator 204b demodulates the broadcast signals selected by the tuner 204a, obtains a transport stream containing the desired program, and outputs them to a TS decoder 204c.

The TS decoder 204c performs TS decoding processing on the TS multiplexed signals on the basis of control signals from the controller 205, and outputs a PES obtained by de-packetizing digital image signals and sound signals of the desired program to the STD buffer in the signal processor 206. The TS decoder 204c outputs section information transmitted through digital broadcasting to the section processor in the signal processor 206.

During television viewing, the signal processor 206 selectively performs given digital signal processing on the digital image signals and sound signals provided from each of the TS decoder 202c and the TS decoder 204c, and outputs the processed signals to a graphic processor 207 and a sound processor 208. During recording of a program, the signal processor 206 stores, in a storage (HDD, for example) 270, thorough the controller 205, the signals obtained after given digital signal processing is performed selectively on the digital image signals and sound signals provided from each of the TS decoder 202c and the TS decoder 204c. When the recorded program is reproduced, the signal processor 206 performs given digital signal processing on the data of the recorded program read out from the storage (HDD, for example) 270 through the controller 205, and outputs the processed data to the graphic processor 207 and the sound processor 208.

The controller 205 has various data for obtaining programs (key information for B-CAS descramble, etc.), electronic program guide (EPG) information, program attribute information (program genre, etc.), subtitle information (service information, specific information (SI), program specific information (PSI)), etc. that are input from the signal processor 206. The controller 205 performs image generation processing for displaying EPG or subtitles on the basis of the input information, and outputs the generated image information to the graphic processor 207.

The controller 205 also has a function of controlling program recording and program timer recording. When timer recording is accepted, the controller 205 displays EPG information on an external display device (digital television broadcast receiver, for example), and sets recording details to a given memory on the basis of a viewer input through an operation portion 220 or a remote controller 221. Then, the controller 205 controls the tuners 202a, 204a, the PSK demodulator 202b, the OFDM demodulator 204b, the TS decoders 202c, 204c, and the signal processor 206 to record a reserved program at set time.

The section processor outputs various data for obtaining programs, EPG information, program attribute information (program genre, etc.), subtitle information (service information, SI, PSI), etc., among the section information input from the TS decoder 202c (204c), to the controller 205.

The graphic processor 207 has a function of synthesizing (1) digital image signals supplied from an audio visual (AV) decoder (not shown) in the signal processor 206, (2) on screen display (OSD) signals generated by an OSD signal generating module 209, (3) image data by data broadcasting, and (4) EPG, and subtitle signals generated by the controller 205, and outputting the resulting signals to an image processor 210.

To display subtitles in a broadcast with captions, the graphic processor 207 superposes subtitle information on the image signals on the basis of the subtitle information by controller of the control 205.

The digital image signals output from the graphic processor 207 are supplied to the image processor 210. The image processor 210 converts the input digital image signals into analog image signals in a format that can be displayed by a display 214, or an external device connected through an output terminal 211, and then outputs the analog signals to the output terminal 211 or the display 214 for image display.

The sound processor 208 converts the input digital sound signals to analog sound signals in a format that can be reproduced by a speaker 213, and then outputs the analog sound signals to an external device connected through an output terminal 212 or the speaker 213 for sound reproduction.

Here, all of the actions of the television broadcast receiver 100, including the various reception actions described above, are integrally controlled by the controller 205. The controller 205 has therein a central processing unit (CPU), etc. Receiving operation information from the operation portion 220, or receiving, through a light receiving module 222, operation information transmitted from the remote controller 221, the controller 205 controls each of the modules so that the operation contents are reflected.

In this case, the controller 205 mainly uses a read only memory (ROM) 205a storing a control program executed by the CPU, a random access memory (RAM) 205b providing the CPU with a work area, and a nonvolatile memory 205c storing various setting information, control information, etc.

The controller 205 is connected, through a card interface (I/F) 223, to a card holder 225 in which a memory card 224 can be attached. Thus, the controller 205 can transmit and receive information to and from the memory card 224 attached in the card holder 225, through the card I/F 223.

The controller 205 is connected to a first LAN terminal 232 through a communication I/F 231. Thus, the controller 205 can transmit and receive information to and from a LAN-supported device connected to the first LAN terminal 232, through the communication I/F 231.

The controller 205 is connected to a USB terminal 234 through a USB I/F 233. Thus, the controller 205 can transmit and receive information to and from various devices (external hard disk drive, for example) connected to the USB terminal 234, through the USB I/F 233.

The controller 205 of the television broadcast receiver 100 is provided with a content processing application 250. The CPU of the controller 205 reads the content processing application 250, so that each configuration of the content processing application 250 is realized on the RAM 205b.

Next, the configuration realized by the content processing application 250 of the television broadcast receiver 100, and the configuration realized in the portable HDD 150 are described.

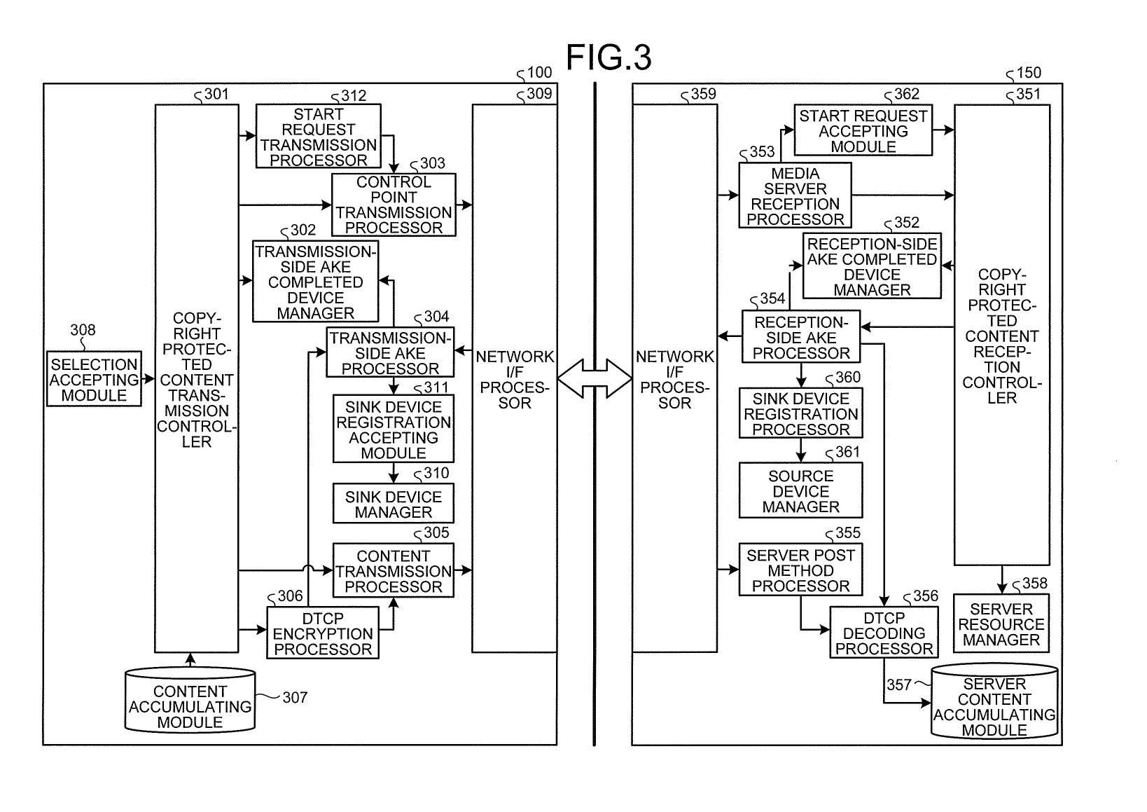

FIG. 3 is a diagram of the configuration realized by the content processing application 250 of the television broadcast receiver 100 and the configuration realized in the portable HDD 150.

As illustrated in FIG. 3, the television broadcast receiver (DTCP source device) 100 comprises a copyright protected content transmission controller 301, a transmission-side AKE completed device manager 302, a control point transmission processor 303, a transmission-side AKE processor 304, a content transmission processor 305, a DTCP encryption processor 306, a content accumulating module 307, a selection accepting module 308, a network I/F processor 309, a sink device manager 310, a sink device registration accepting module 311, and a start request transmission processor 312.

The network I/F processor 309 is an interface for connection with a network. The network I/F processor 309 of the embodiment receives TCP/IP processing requests from the control point transmission processor 303, the transmission-side AKE processor 304, and the content transmission processor 305, and performs communication with a DTCP sink device (portable HDD 150, for example).

The copyright protected content transmission controller 301 performs system control for transmitting contents to a DTCP sink device (portable HDD 150, for example).

The selection accepting module 308 accepts selection of instruction from a user.

The selection accepting module 308 of the embodiment accepts selection of a DTCP sink device to which a device registration start request is transmitted. The device registration start request of the embodiment is a request (instruction) for prompting a device to which a device registration start request is sent to transmit a device registration request that is necessary for transmitting copyright protected contents to a device that sends the device registration start request. That is, in the embodiment, in response to the device registration start request sent, the device registration request is transmitted from the device to which the device registration start request is sent. In this manner, the device to which the device registration start request is sent can transmit a device registration request regardless of whether it is provided with a user interface.

The DTCP sink device selected by the selection accepting module 308 is a destination device to which contents are transmitted through a public network line in accordance with DTCP-IP RA, and exists, currently, in a network (not through a public network) same as of the television broadcast receiver 100 (domestic network, for example). Although a case in which DTCP-IP RA is used as a technical standard for transmitting contents protected by copyright protection technology will be described in the embodiment, other technical standard may be used.

In the embodiment, whether the DTCP sink device exists in a same network as of the television broadcast receiver 100 is determined depending on whether it exists within a predetermined number of round trip time (RTT) or a predetermined number of time to live (TTL) from the television broadcast receiver 100. Note that the values of RTT and TTL are defined depending on actual embodiments.

A list of candidates for the DTCP sink devices whose selection are accepted by the selection accepting module 308 is displayed by the image processor 210.

The start request transmission processor 312 generates a device registration start request for a DTCP sink device (portable HDD 150, for example) to which dubbed contents are transmitted. The DTCP sink device to which the device registration start request is transmitted is a DTCP sink device whose selection is accepted by the selection accepting module 308.

Then, the start request transmission processor 312 transmits the device registration start request to a start request accepting module 362 of a DTCP sink device (portable HDD 150, for example). The device registration start request will be described later as a CDS:X_xxx_StartRemoteRegistration action in the embodiment. The action requests transmission of at least an IP address (of the DTCP sink device) and a port number (for AKE processing) as identification information for registering the device at least as a destination device. The attributes as a server (server name, function, identification information, etc.) may not be included in the action as long as they can be obtained by other method. For example, the attributes may be obtained by DLNA's function of discovering and controlling devices.

The device registration start request may include identification information identifying the DTCP source device in which the DTCP sink device is registered. The identification information includes a DTCP device ID of the DTCP source device, for example. Thus, the DTCP sink device (portable HDD 150, for example) compares the DTCP device ID of the client obtained in the device registration procedure (RSR procedure) with the DTCP device ID included in the registration start request and, if the IDs are different from each other, the DTCP sink device can cancel the device registration procedure (RSR procedure) regarding the registration start request as wrong. When the IP address of the requestor of the registration start request is different from the IP address of the client, the registration start request may be excluded.

Furthermore, after transmitting the registration start request, the DTCP source device (television broadcast receiver 100, for example) may reject the start of device registration procedure of devices other than the DTCP sink device (portable HDD 150, for example) to which the registration start request is transmitted.

In the embodiment, the device registration is not limited to direct registration between two devices, and may involve further a controller device. The device registration request through the controller device includes specification of a method of notification to the controller device. Then, the DTCP sink device can respond with the result of device registration procedure (RSR procedure) in the specified notification method.

The sink device registration accepting module 311 accepts the device registration request transmitted from a sink device registration processor 360 of the DTCP sink device (portable HDD, for example), and performs registration processing in accordance with the device registration request. In the registration processing, the sink device registration accepting module 311 receives, from the DTCP sink device to be registered, a DTCP device ID, etc. identifying the DTCP sink device. Then, the received DTCP device ID, etc. are stored in the sink device manager 310. In this manner, the device registration for transmitting copyright protected contents is completed.

The sink device manager 310 manages device information of the DTCP sink device that is already subjected to registration processing by the sink device registration accepting module 311.

The control point transmission processor 303 transmits a control instruction to a media server reception processor 353 of the DTCP sink device to which copyright protected contents are transmitted.

The transmission-side AKE processor 304 performs transmission-side AKE processing.

The transmission-side AKE completed device manager 302 stores information of devices that are already subjected to AKE.

The selection accepting module 308 accepts selection of copyright protected contents to be transmitted, and selection of a DTCP sink device to which the contents are transmitted.

Then, the selection accepting module 308 outputs the accepted selection contents to the copyright protected content transmission controller 301, which starts dubbing (MOVE) processing of the selected contents.

The content transmission processor 305 performs processing regarding the client (DTCP sink device) with the HTTP POST method, and transmits contents to the DTCP sink device (portable HDD 150, for example). In the embodiment, the contents to be transmitted are contents whose selection is accepted by the selection accepting module 308. In the embodiment, the DTCP sink device as a transmission destination is a DTCP sink device whose selection is accepted by the selection accepting module 308.

When the content transmission processor 305 of the embodiment transmits contents to a DTCP sink device, if the DTCP sink device is already registered, the content transmission processor 305 can transmit the contents protected by copyright protection technology through a public network line.

The DTCP encryption processor 306 encrypts the copyright protected contents using an encryption method defined by DTCP.

The content accumulating module 307 records the copyright protected contents in an accumulated manner.

The portable HDD 150 serves as a DTCP sink device, and comprises a copyright protected content reception controller 351, a reception-side AKE completed device manager 352, the media server reception processor 353, a reception-side AKE processor 354, a server POST method processor 355, a DTCP decoding processor 356, a server content accumulating module 357, a server resource manager 358, a network I/F processor 359, the sink device registration processor 360, a source device manager 361, and a start request accepting module 362.

The copyright protected content reception controller 351 performs system control for receiving copyright protected contents from the DTCP source device (television broadcast receiver 100, for example). In the embodiment, the reception control for dubbing copyright protected contents is exemplified.

The reception-side AKE completed device manager 352 stores information of devices that are already subjected to AKE.

The media server reception processor 353 receives a control instruction transmitted from the control point transmission processor 303 of the DTCP source device as a client, and operates according to the control instruction.

The reception-side AKE processor 354 performs reception-side AKE processing.

The server POST method processor 355 performs processing regarding a server with the HTTP POST method, and receives contents from the DTCP source device as a client.

The DTCP decoding processor 356 decodes encrypted copyright protected contents in a decoding method defined by DTCP.

The server content accumulating module 357 records copyright protected contents in an accumulated manner.

The server resource manager 358 manages resources of the own device as a server, which are for storing copyright protected contents transmitted from the DTCP source device as a client.

The network I/F processor 359 receives TCP/IP processing requests from the media server reception processor 353, the reception-side AKE processor 354, and the server POST method processor 355, and performs communication with the client device (DTCP source device).

The source device manager 361 manages device information of the DTCP source device that is already subjected to registration processing by the sink device registration processor 360.

The start request accepting module 362 accepts a registration start request from the DTCP source device as a client (television broadcast receiver 100, for example). Then, the start request accepting module 362 instructs the sink device registration processor 360 to start the device registration procedure (RSR procedure) for registration in the DTCP source device specified by the registration start request.

After performing AKE processing with the DTCP source device as a client (television broadcast receiver 100, for example), the sink device registration processor 360 generates a device registration request for the sink device registration accepting module 311 of the DTCP source device.

Then, the sink device registration processor 360 transmits the generated device registration request to the sink device registration accepting module 311 of the DTCP source device (television broadcast receiver 100, for example). In the embodiment, with the device registration request as a trigger, device information registration processing is performed between the mutual devices.

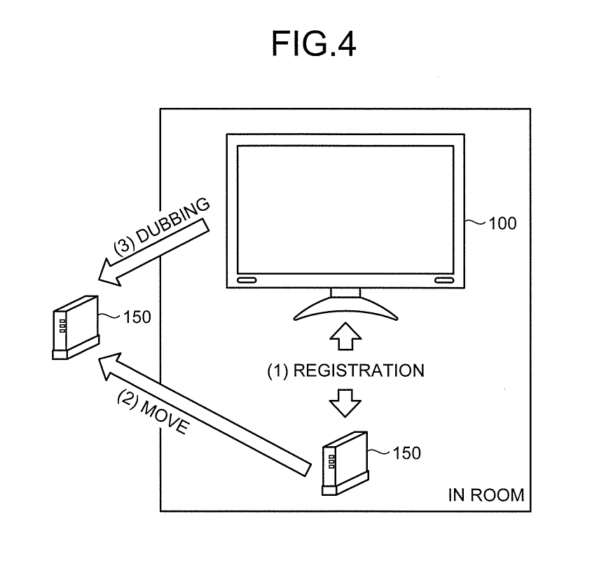

FIG. 4 is a conceptual diagram of processing performed between the digital television broadcast receiver 100 in the embodiment and the portable HDD 150. As illustrated by (1) of FIG. 4, when the portable HDD 150 is in one's home, the device registration is performed mutually between the television broadcast receiver 100 and the portable HDD 150. After the devices are registered, the portable HDD 150 can be brought out to the outside of the home, as illustrated by (2) of FIG. 4. Then, when a user desires to view contents with the portable HDD 150, copyright protected contents are pushed (PUSH) from the digital television broadcast receiver 100, after mutual authentication, so that the contents are dubbed to the portable HDD 150, as illustrated by (3) of FIG. 4. Thus, since the devices are preliminarily registered in the room, it is possible to view copyright protected contents outside the room, only for personal use.

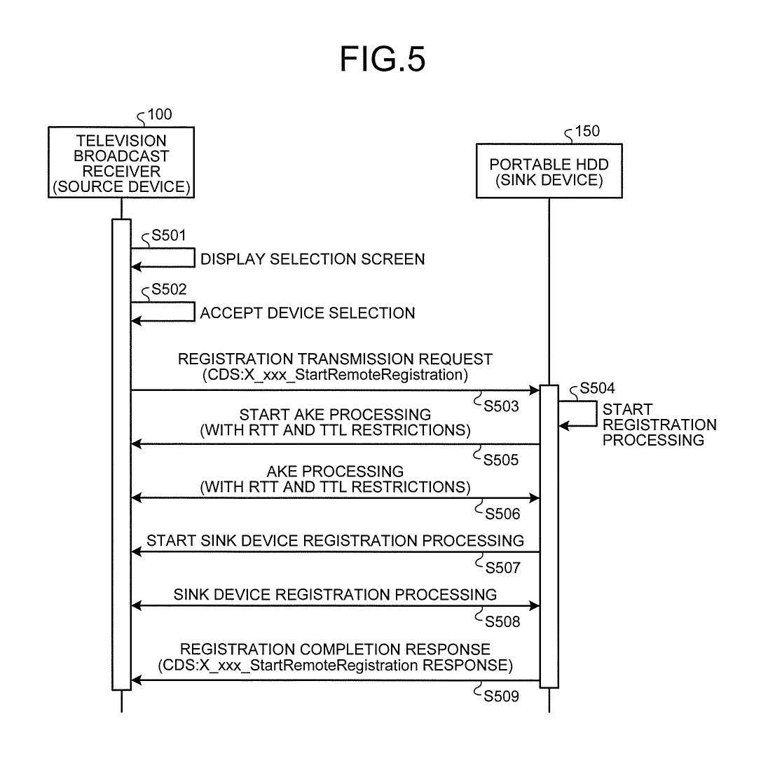

Next, the concrete procedure of registering devices will be described. FIG. 5 is a diagram of a sequence of device registration between devices (television broadcast receiver 100 and portable HDD 150, for example) in the embodiment. The device registration is performed for transmitting and receiving copyright protected contents.

First, the image processor 210 of the television broadcast receiver 100 displays a selection screen for selecting a device to be registered on the display 214 (S501).

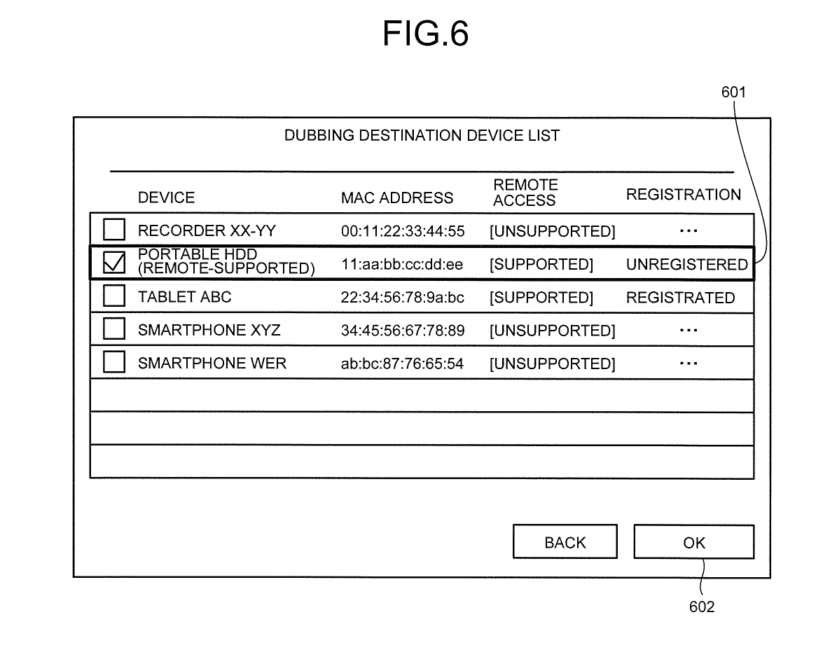

FIG. 6 is a diagram of an example of the selection screen for selecting a device to be registered. As illustrated in FIG. 6, on the selection screen, each device is displayed in association with a device name, a media access control (MAC) address, whether remote access supported or not, and whether registered or not. The MAC address is used as identification information of the device. Whether remote access supported or not indicates whether the device can receive contents even in the outside of one's home. In the embodiment, the screen example is of the digital television broadcast receiver 100. However, the screen is not limited to of the digital television broadcast receiver 100. As long as the device is a DTCP source device, the screen example of the same kind can be displayed. With operation on a cross cursor button on a remote controller of the digital television broadcast receiver 100, etc., various devices displayed on the screen example can be selected.

The selection accepting module 308 accepts, from a user, selection of a DTCP sink device that is not registered among remote access supported DTCP sink devices (S502). In the example of FIG. 6, the portable HDD displayed in an area 601 is selected. In this manner, when the selection (input of a check mark) among remote access supported devices is accepted, and a press of a registration button 602 is received, the DTCP sink device registration procedure is started.

The start request transmission processor 312 of the digital television broadcast receiver 100 transmits a CDS:X_xxx_StartRemoteRegistration action following universal plug and play (UPnP) to the portable HDD 150 as a registration transmission request (S503). In the embodiment, the portable HDD 150 that needs to be preliminarily registered in the digital television broadcast receiver 100 is not provided with a user interface, etc. and thus cannot transmit a preliminary registration request by itself. Then, in the embodiment, the start request transmission processor 312 transmits the CDS:X_xxx_StartRemoteRegistration action to the portable HDD 150 so as to prompt the portable HDD 150 to transmit a registration request.

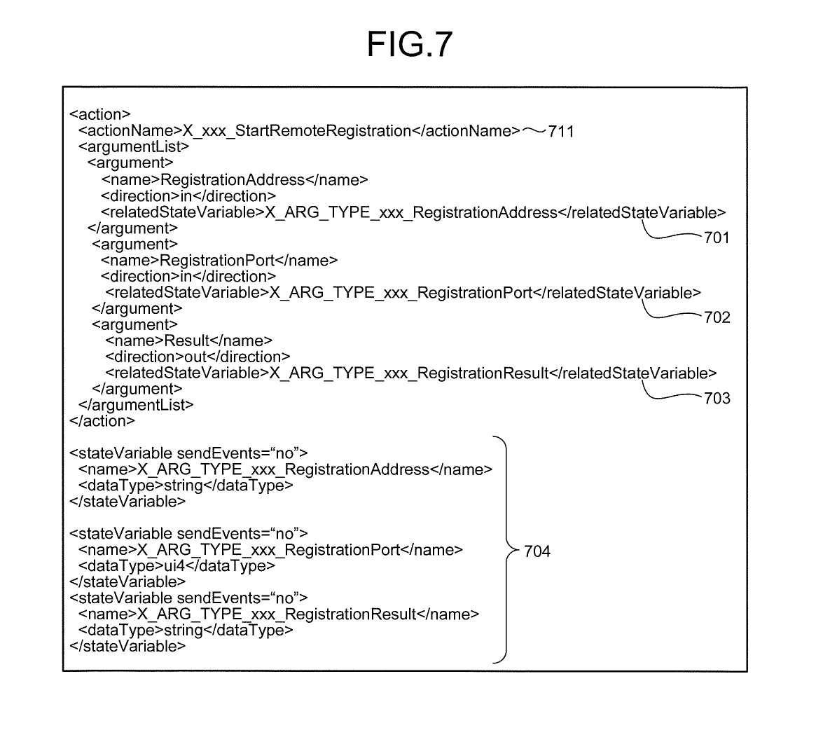

FIG. 7 is a diagram of a first example of information included in a CDS:X_xxx_StartRemoteRegistration action 711. As illustrated in FIG. 7, the CDS:X_xxx_StartRemoteRegistration action 711 includes “X_ARG_TYPE_xxx_RegistrationAddress” 701, “X_ARG_TYPE_xxx_RegistrationPort” 702, and “X_ARG_TYPE_xxx_RegistrationResult” 703. The “X_ARG_TYPE_xxx_RegistrationAddress” 701 is a variable defining an IP address of a DTCP source device for which the registration is requested (television broadcast receiver 100 in the example of FIG. 7). The “X_ARG_TYPE_xxx_RegistrationPort” 702 is a variable defining a port number for which the registration is requested. The “X_ARG_TYPE_xxx_RegistrationResult” 703 is a variable defining a result of registration request. As illustrated in FIG. 7, the IP address and the device registration port of a registration request destination may be the argument of X_xxx_StartRemoteRegistration. However, other form maybe used. Similarly, also for the result of registration request, other form may be used. In an area 704, the types of various variables are defined.

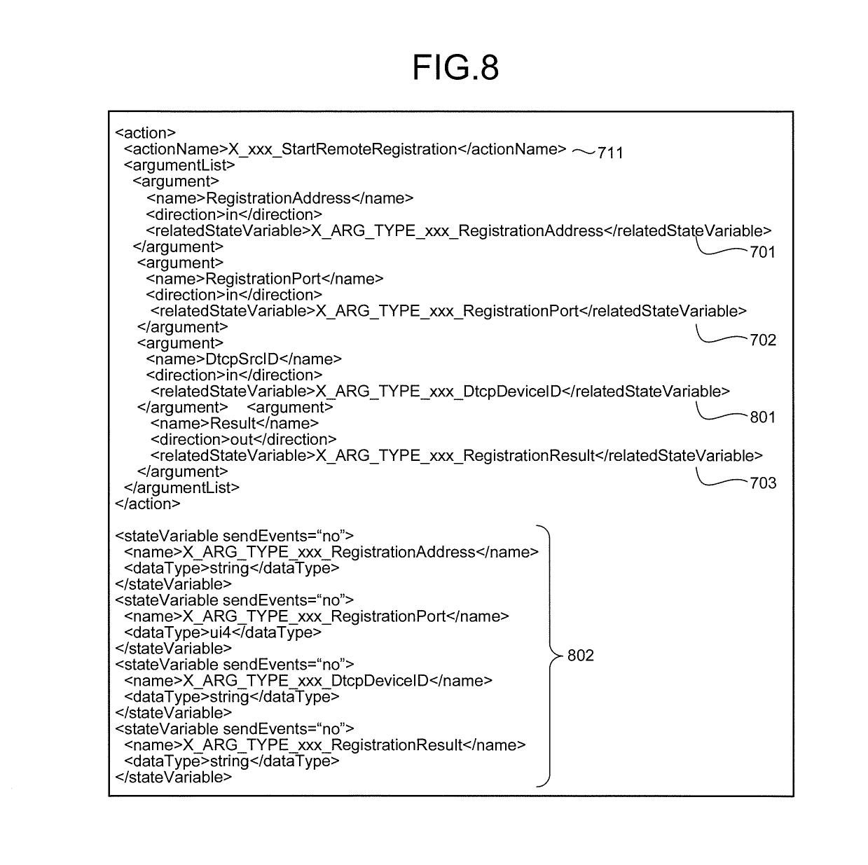

The CDS:X_xxx_StartRemoteRegistration action 711 may include a definition of the DTCP device ID for mutual registration. FIG. 8 is a diagram of a second example of information included in the CDS:X_xxx_StartRemoteRegistration action 711. In the example of FIG. 8, a variable defining a DTCP device ID “X_ARG_TYPE_xxx_DtcpDeviceID” 801 is further added to the examples illustrated in FIG. 7. Moreover, in an area 802, the types of various variables including the variable “X_ARG_TYPE_xxx_DtcpDeviceID” are defined. Thus, the destination to which the CDS:X_xxx_StartRemoteRegistration action 711 is transmitted can recognize information necessary for transmission for registration request.

Receiving the X_xxx_StartRemoteRegistration action, the portable HDD 150 as a DTCP sink device notifies the start request accepting module 362 of the device registration start request, and transfers the IP address and the device registration port number of the transmission destination to the start request accepting module 362. Then, with the reception of such information by the start request accepting module 362 as a trigger, the device registration processing is started (S504).

The start request accepting module 362 instructs the reception-side AKE processor 354 to start AKE processing. Then, the reception-side AKE processor 354 starts AKE processing with the transmission-side AKE processor 304 of the television broadcast receiver 100 (S505). Thereafter, the AKE processing is performed between the reception-side AKE processor 354 of the portable HDD 150 and the transmission-side AKE processor 304 of the digital television broadcast receiver 100 (S506). In S505 and S506, RTT and TTL restrictions are applied. Thus, the DTCP sink devices to be registered are limited to ones in a network same as of the DTCP source device (domestic network, for example). In this manner, the use of contents can be limited to personal use.

With the completion of AKE processing as a trigger, the sink device registration processor 360 of the DTCP sink device (portable HDD 150, for example) starts device registration processing relative to the sink device registration accepting module 311 of the DTCP source device (television broadcast receiver 100, for example) (S507). Thus, the sink device registration accepting module 311 registers the DTCP device ID of the DTCP sink device in the sink device manager 310 (S508). Note that also on the side of the portable HDD 150, the DTCP device ID specifying the DTCP source device may be registered in the source device manager 361.

After the device registration of the DTCP sink device is finished, the start request accepting module 362 transmits a response with a result notification regarding the sink device registration processing in accordance with the device registration start request accepted (S509). The response with the result notification is made as a response to the X_xxx_StartRemoteRegistration action.

The embodiment does not limit the procedure to one described above. As a response to the X_xxx_StartRemoteRegistration action, only the start of device registration may be notified, and the result of device registration processing may be notified through other inquiry action response or UPnP event notice.

In the X_xxx_StartRemoteRegistration action, the DTCP device ID of the DTCP source device (television broadcast receiver 100, for example) may be notified to the DTCP sink device (portable HDD 150, for example). Then, when the sink device registration is performed in the DTCP sink device (portable HDD 150, for example), if a DTCP device ID of a DTCP source device being treated is different from the one given in the X_xxx_StartRemoteRegistration action, it is possible to make the sink device registration processing failed and interrupted. In this case, it can be considered that the DTCP device ID is included in the X_xxx_StartRemoteRegistration action as an input argument, as illustrated in the above FIG. 8. In this case, the DTCP device ID of the DTCP source device as a calling side is notified to the DTCP sink device as a called side.

The X_xxx_StartRemoteRegistration UPnP action may be defined as an expansion action for an existing UPnP service of an existing UPnP device or the X_xxx_StartRemoteRegistration UPnP action may be defined as an action of a new UPnP service of an existing UPnP device. Furthermore, the X_xxx_StartRemoteRegistration UPnP action may be defined as an action of a new UPnP service of a new UPnP device. In the example, the X_xxx_StartRemoteRegistration UPnP action is defined as an action belonging to ContentDirectry service, and used. The DTCP sink device as a server presents that it has the registration action (responding with an action of the UPnP service, or responding to a call of a given form), so that the DTCP source device as a client can recognize that the DTCP sink device supports the device registration start request in the predetermined form.

In the processing procedure described above, the device registration with the DTCP device ID is performed. The transmission and reception of copyright protected contents become possible between devices that are already subjected to device registration.

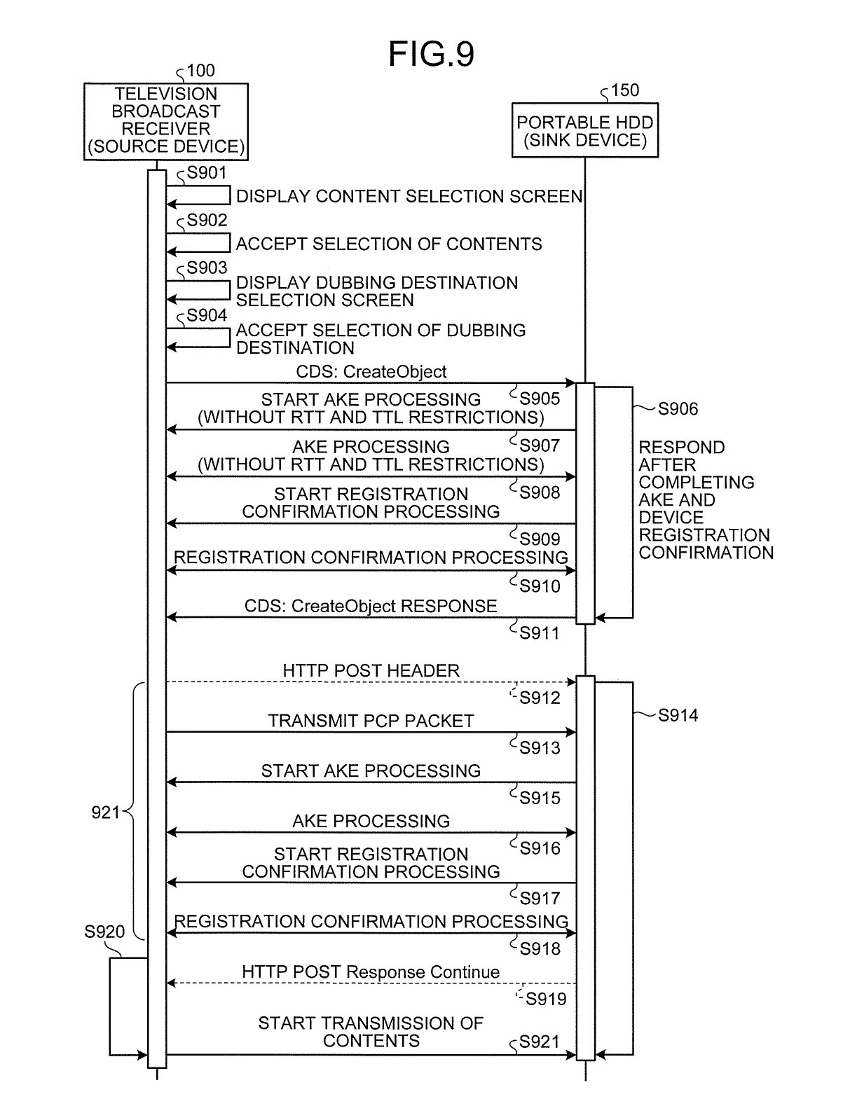

FIG. 9 is a diagram of a sequence of transmission and reception of copyright protected contents between the devices in the embodiment (digital television broadcast receiver 100 and portable HDD 150, for example).

The image processor 210 of the DTCP source device as a client (television broadcast receiver 100, for example) displays a content selection screen (S901).

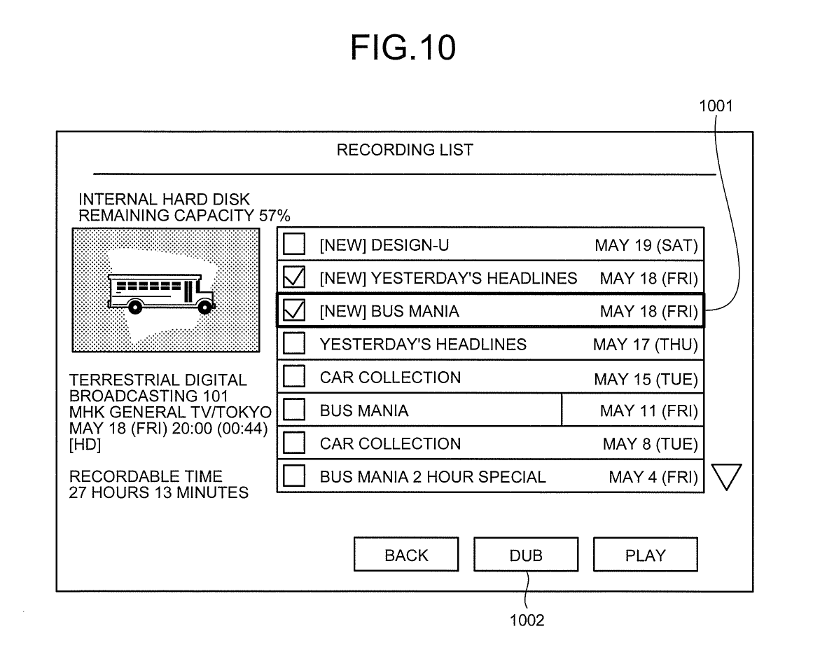

FIG. 10 is a diagram of an example of the content selection screen. The example illustrated in FIG. 10 is a list of copyright protected contents stored in the DTCP source device. In the example illustrated in FIG. 10, a focus 1001 points to “BUS MANIA”.

Then, the selection accepting module 308 accepts selection of copyright protected contents to be dubbed (S902). In the example illustrated in FIG. 10, “YESTERDAY'S HEADLINES” and “BUS MANIA” are selected as targets to be dubbed. Then, when a dubbing button 1002 is pressed, the image processor 210 displays a dubbing destination selection screen (S903).

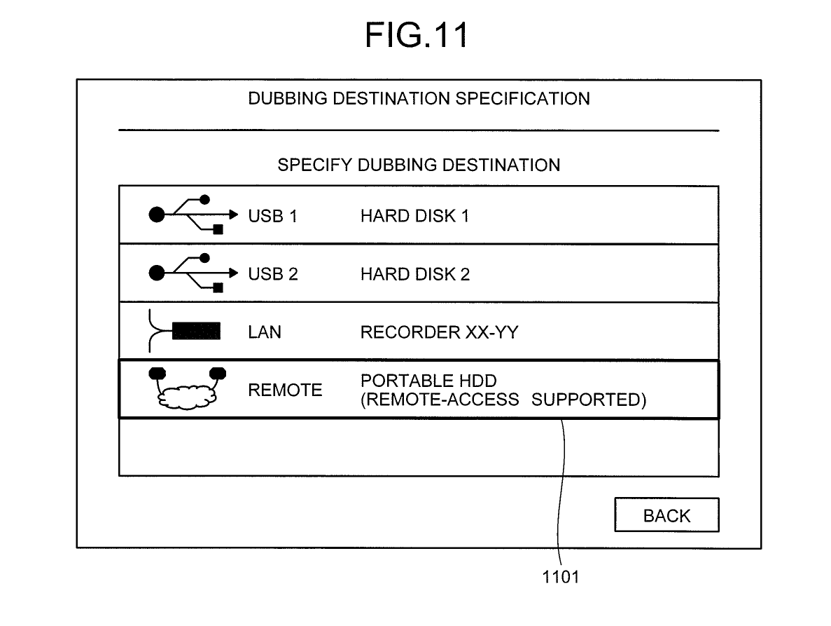

FIG. 11 is a diagram of an example of the dubbing destination selection screen. The example illustrated in FIG. 11 is a list of preliminarily registered DTCP sink devices. In the example illustrated in FIG. 11, a focus 1101 points to a “PORTABLE HDD (REMOTE ACCESS SUPPORTED)” as a dubbing destination.

Subsequently, the selection accepting module 308 accepts selection of a DTCP sink device as a dubbing destination (S904). In the embodiment, “YESTERDAY'S HEADLINES” and “BUS MANIA” that are selected in the example illustrated in FIG. 10 are determined as contents to be transmitted. When a return button is pressed, the screen returns to of content selection.

The DTCP sink device to which copyright protected contents are dubbed is preliminarily registered already, and thus it is clarified that the contents are for personal use. In this way, the DTCP sink device is not necessarily in a network same as of the DTCP source device (domestic network, for example). Thus, in the AKE processing that is performed subsequently, the restrictions of RTT and TTL are not applied.

When the DTCP source device (television broadcast receiver 100, for example) moves (MOVE) the selected copyright protected contents to the DTCP sink device (portable HDD 150, for example), it transmits a CDS:CreateObject action of ContentDirectoryService defined by UPnP AV (S905). Thus, processing until registration confirmation is started in the DTCP sink device (portable HDD 150, for example) (S906). In the CDS:CreateObject action, the port number and the IP address of the own device for AKE processing are added as properties.

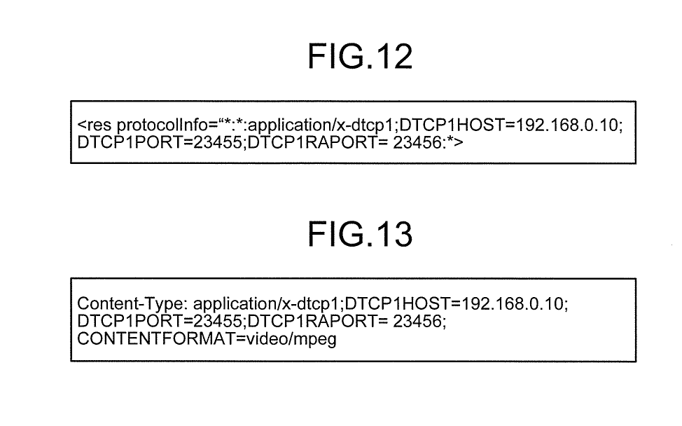

FIG. 12 is a diagram of an example of information included in the CDS:CreateObject action of ContentDirectoryService. As illustrated in the example of FIG. 12, each value is defined in the fourth field of res protocolInfo. In the example of FIG. 12, the port number is 23455, and the host address is 192.168.0.10.

Receiving the CDS:CreateObject action request, the DTCP sink device (portable HDD 150, for example) refers to the reception-side AKE completed device manager 352, and confirms, using the IP address, whether the DTCP source device is a device with which AKE processing is already performed. The sequence illustrated in FIG. 9 is an example in which the AKE processing is not already performed.

Then, the reception-side AKE processor 354 starts AKE processing with the transmission-side AKE processor 304 (S907). Then, the AKE processing is performed between the reception-side AKE processor 354 and the transmission-side AKE processor 304 (S908).

In the example illustrated in FIG. 9, there is no restriction regarding RTT or TTL in AKE processing. Thus, copyright protected contents can be moved (MOVE) to a DTCP sink device that is in the outside of the home. However, since it is required to secure copyright protection, the processing of confirming if the DTCP device ID is of the DTCP sink device that is preliminarily registered is started.

The reception-side AKE processor 354 of the DTCP sink device requests the transmission-side AKE processor 304 of the DTCP source device to start registration confirmation (S909). Then, the processing of confirming if the DTCP device ID is preliminarily registered is performed between the reception-side AKE processor 354 and the transmission-side AKE processor 354 of the DTCP source device (S910). In the confirmation processing, the reception-side AKE processor 354 of the DTCP sink device transmits the DTCP device ID identifying the own device to the transmission-side AKE processor 354 of the DTCP source device. Then, the transmission-side AKE processor 354 confirms if the received DTCP device ID is registered referring to the sink device manager 310. In the example illustrated in FIG. 9, the DTCP device ID is preliminarily registered.

Then, after the AKE processing and the registration confirmation processing are completed, requested resources are secured on the side of the DTCP sink device, while the reception-side AKE processor 354 responds to the CDS:CreateObject (S911). That is, the resources are secured after the AKE processing and the registration confirmation processing are completed, which prevents the occurrence of a situation in which AKE processing or registration confirmation processing is failed although the resources are secured.

Next, the content transmission processor 305 of the DTCP source device as a client (television broadcast receiver 100, for example) transmits only header data to a uniform resource locator (URL) of the responder to the CDS:CreateObject action, using the HTTP POST method for content transmission (S912).

FIG. 13 is a diagram of an example of information included in the header data. In the example illustrated in FIG. 13, the header data has a Content-Type entity header, and the port number and the host address of the DTCP source device (television broadcast receiver 100, for example) that are used in AKE processing are indicated. Moreover, the header data indicates that CONTENTFORMAT is of video/mpeg. Using an Expect mechanism defined by HTTP 1.1, an Expect: 100-continue header is included.

Here, the DTCP source device as a client (television broadcast receiver 100, for example) starts to transmit an HTTP body with a content length (CL) of a protected content packet (PCP) being 0 including no content body, as an HTTP POST body, to the DTCP sink device as a server (portable HDD 150, for example) until the AKE processing with the DTCP sink device is completed (S913). Note that, during a term represented by a term 921, only Empty is transmitted continuously until the confirmation of device registration is completed.

The DTCP sink device (portable HDD 150, for example) performs processing for starting to read out the content body with the reception of HTTP POST method as a trigger (S914). First, the DTCP sink device (portable HDD 150, for example) reads out only the head portion of the HTTP POST method received at S911, and confirms if the AKE processing is already performed with the DTCP source device as a client (television broadcast receiver 100, for example), using the IP address. When the AKE processing is not already performed (when the IP address of the DTCP sink device is changed after the CDS:CreateObject action request, for example), the DTCP sink device (portable HDD 150, for example) starts AKE processing relative to the port number and the host address obtained from a request in the form illustrated in FIG. 13 (S915). Then, the AKE processing is performed between the reception-side AKE processor 354 and the transmission-side AKE processor 304 (S916).

Then, the reception-side AKE processor 354 of the DTCP sink device requests the transmission-side AKE processor 354 of the DTCP source device to start registration confirmation (S917). Thus, the confirmation processing if the DTCP device ID is preliminarily registered is performed between the reception-side AKE processor 354 and the transmission-side AKE processor 304 of the DTCP source device (S918).

Then, the server POST method processor 355 responds to the DTCP source device as a client (television broadcast receiver 100, for example), with “100 Continue” as HTTP POST response (S919).

The content transmission processor 305 of the DTCP source device (television broadcast receiver 100, for example) performs control for transmitting contents after registration confirmation processing is finished (S920).

Then, when the DTCP source device (television broadcast receiver 100, for example) receives the response of HTTP POST method illustrated at S916, the content transmission processor 305 stores contents that is already subjected to encryption processing by the DTCP encryption processor 306 in a PCP, and transmits the PCP, as an HTTP body, to the DTCP sink device (portable HDD 150, for example) (S921).

That is, in the sequence illustrated in FIG. 9, the HTTP body with a CL of a PCP being 0 including no content body is transmitted and received until the AKE processing and the device registration confirmation are completed. Then, after the AKE processing and the device registration confirmation are completed, the transmission and the reception of the HTTP body including the encrypted content body are started.

In the embodiment, the television broadcast receiver 100 is exemplified as a DTCP source device. However, the DTCP source device may be any device as long as it can provide copyright contents, and may be a digital versatile disk (DVD) recorder device, for example. Similarly, the DTCP sink device may be any device other than the portable HDD 150 as long as it can store copyright protected contents, and may be a portable tablet device, or a mobile communication terminal, for example.

In the embodiment, an example in which the DTCP sink device is moved to the outside of one's home will be described. However, the device to be moved to the outside of the home is not limited thereto, and may be a DTCP source device.

Thus, it is possible to prevent a case in which copyright protected contents are transmitted to a device that is not registered, and a case in which encryption cannot be canceled and thus a part of contents is lost.

In the embodiment described above, the operation on the DTCP source device side serving as a single-function client that supports dubbing only (not supports reproduction), allows preliminary device registration of the DTCP-IP RA without operation on the DTCP sink device serving as a server. In this manner, even if the DTCP sink device is not provided with a user interface, preliminary registration is possible. Therefore, the burden with respect to operation is reduced, and thus the convenience is improved.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processor comprising:
an accepting module configured to accept selection of a transmission destination device to which data is transmitted through a public network line in accordance with a technical standard for transmitting data protected by copyright protection technology, the transmission destination device currently existing in a given environment around the data processor not through the public network line;
a first transmission processor configured to transmit a request for transmission of a device registration request including identification information for identifying the transmission destination device based on the technical standard, to the transmission destination device;
a receiving module configured to receive the device registration request including the identification information from the transmission destination device; and
a second transmission processor configured to transmit the data protected by the copyright protection technology to the transmission destination device identified by the identification information, through the public network line.

2. The data processor of claim 1, wherein the transmission destination device whose selection is accepted by the accepting module is configured to exist within a predetermined number of round trip time (RTT) or a predetermined number of time to live (TTL) from the data processor, as in the given environment.

3. The data processor of claim 1, wherein the technical standard used by the second transmission processor for transmitting the data is a digital transmission content protection over Internet protocol (DTCP-IP) standard, or a standard using the DTCP-IP.

4. The data processor of claim 1, further comprising a memory configured to store therein the identification information received by the receiving module, wherein
when the second transmission processor transmits the data to the transmission destination device, the second transmission processor transmits the data to the transmission destination device when it is confirmed that the identification information identifying the transmission destination device is stored in the memory.

5. The data processor of claim 1, further comprising a display processor configured to display a list screen of candidate devices as candidates to which the request for transmission of the identification information is transmitted, wherein
the accepting module is configured to accept selection of the transmission destination device among the candidate devices displayed in the list screen.

6. A communication device to which data is transmitted through a public network line in accordance with a technical standard for transmitting data protected by copyright protection technology, currently existing in a given environment around a data processor configured to transmit the data not through the public network line, the communication device comprising:
a reception processor configured to receive a request for transmission of a device registration request including identification information for identifying the communication device based on the technical standard; and
a transmission processor configured to transmit the device registration request including the identification information for identifying the communication device based on the technical standard, to the data processor.

7. A data transmission method performed by a data processor, the data transmission method comprising:
accepting selection of a transmission destination device to which data is transmitted through a public network line in accordance with a technical standard for transmitting data protected by copyright protection technology, the transmission destination device currently existing in a given environment around the data processor not through the public network line;
first transmitting a request for transmission of a device registration request including identification information identifying the transmission destination device based on the technical standard, to the transmission destination device;
receiving the device registration request including the identification information from the transmission destination device; and
second transmitting the data protected by the copyright protection technology to the transmission destination device identified by the identification information, through the public network line.
